(19) United States
(12) Patent Application Publication
(10) Pub. No.: US 2006/0245085 A1
(43) Pub. Date: Nov. 2, 2006

(54) Lens transfer device improved in assemblability

(76) Inventors: Cheong Hee Lee, Yongin (KR); Ho Seop Jeong, Sungnam (KR); Jae Ho Baik, Busan (KR)

Correspondence Address: LOWE HAUPTMAN BERNER, LLP, 1700 DIAGONAL ROAD, SUITE 300, ALEXANDRIA, VA, 22314, US

(21) Appl. No.: 11/331,167

(22) Filed: Jan. 13, 2006

(30) Foreign Application Priority Data
Apr. 18, 2005 (KR) 10-2005-31950

(51) Int. Cl. G02B 7/02

(52) U.S. Cl. 359/813

(57) ABSTRACT

A lens transfer device improved in assemblability. The lens transfer device includes a barrel holder. An upper case includes a first holder connector having a protrusion snap-fitted into a groove formed on an upper-outer circumference of the barrel holder, a first leaf spring connected to an outer circumferential portion of the first holder connector, and a first body connected to an outer circumferential portion of the first leaf spring. A lower includes a second holder connector having a protrusion snap-fitted into a groove formed on a lower-outer circumference of the barrel holder, a second leaf spring connected to an outer circumferential portion of the second holder connector, and a second body connected to the second leaf spring. A yoke is provided to mount a magnet assembly and mounted on the lower case. A coil is installed and spaced by a predetermined gap from the magnet assembly.

### RELATED APPLICATION

The present application is based on, and claims priority from, Korean Application Number 2005-31950, filed Apr. 18, 2005, the disclosure of which is hereby incorporated by reference herein in its entirety.

### BACKGROUND OF THE INVENTION

1. Field of the Invention

The present invention relates to a lens transfer device employing a voice coil motor, and more particularly, to a lens transfer device that is improved in assemblability by allowing a leaf spring to be snap-fitted to a barrel holder.

2. Description of the Related Art

Generally, a camera has a plurality of lenses and a focal length of the camera is adjusted by moving the lenses. In recent years, a mobile phone with a camera function has come into the market. Therefore, it becomes possible to take a still image or a moving picture using the mobile phone having the camera function. In order to take high resolution/definition images and moving pictures, the performance of the camera has been gradually improved.

To realize the high resolution/definition images, an auto-focusing function, an optical-zooming function, and the like are required for the camera. Particularly, the auto-focusing function for automatically adjusting the focus relative to an image sensor is essential to take the high resolution image.

To realize the auto-focusing function, a small electric motor is generally used as a driving source for generating rotational force. In addition, a variety of other driving sources such as a driving unit employing a piezoelectric device are also used.

Particularly, a voice coil motor (VCM) that is a kind of linear motor is typically used as the driving source. The VCM generates the driving force using a vibration principle of a speaker. The VCM is classified into a starting coil type and a starting magnet type. The former is designed to reciprocate the coil relative to a stationary magnet. The latter is designed to reciprocate the magnet relative to a stationary coil.

Since the VCM is designed to reciprocate itself, there is no need to convert rotational motion into reciprocal motion. Therefore, the VCM is spotlighted as a driving source for generating the reciprocal motion in a limited space. Specifically, the VCM is well suited for an application for driving a lens of a camera.

A focusing device (a lens transfer device) according to the related art, which employs the VCM, is designed to reciprocate a barrel with a lens by electromagnetic force generated by the Fleming's left-hand rule. This will be now described with reference to FIGS. 1A and 1B.

Referring to FIGS. 1A and 1B, a pair of magnets 13 are fixed on an inner circumference of a yoke 12 having a U-shaped section and a cylindrical barrel holder 22 around which a coil is wound is disposed on an inner circumference of the magnets 13 such that the coil 23 faces the magnet 13.

A lens barrel 21 is screw-coupled to an inner circumference of the barrel holder 22. At least one lens is installed in the lens barrel 21. Therefore, as the barrel holder 22 reciprocates, the focal length varies.

Meanwhile, the yoke 12 is installed on a lower case 11 and an upper case 14 is disposed on the yoke 12.

At this point, the upper case 14 is connected to an upper portion of the barrel holder 22 by a leaf spring 31. That is, the barrel holder 23 is supported by the leaf spring 31 against the upper case 14.

Another leaf spring may be also installed on the lower case 11. In this case, the leaf spring connects the lower case 11 to a lower portion of the barrel holder 22.

The operation of the above-described lens transfer device will be now described.

When a current is applied to the coil 23, electromagnetic force is generated between the coil and the magnets 13. By the electromagnetic field, the barrel holder 22 reciprocates.

At this point, since guide holes 22a formed on the barrel holder 22 are guided by guide plates 12a formed on an inside portion of the yoke 12, the lens 25 installed in the lens barrel 21 screw-coupled to the barrel holder 22 reciprocates in a direction of an optical axis of the lens.

That is, when the barrel holder 22 reciprocates, the lens 25 installed in the lens barrel 21 moves to a position where it can accurately converge light reflected from an object on an image sensor 50, thereby realizing the focusing.

However, the focusing device of the related art has the following problems.

Since the leaf spring is forcedly fitted around an outer circumference 22b of the barrel holder 22 or an outer circumference 21a of the lens barrel 21 and fixed through a bonding process, the leaf spring may be damaged or broken during the forced-fitting process.

In addition, since the leaf spring 31 is fixed to the lens barrel 21 (or barrel holder 22) and/or the upper case 14 through the bonding process, the assembling work is complicated.

Particularly, since the location setting and initial elastic force setting of the leaf spring 31 are not accurate, the initial position of the lens barrel 21 may be deviated from the optical axis. Furthermore, when the lens barrel 21 moves in the direction of the optical axis, the movement may not be accurately realized.

### SUMMARY OF THE INVENTION

Accordingly, the present invention is directed to a lens transfer device that substantially obviates one or more problems due to limitations and disadvantages of the related art.

An object of the present invention is to provide a lens transfer device improved in assemblability, in which a barrel holder and a leaf spring can be easily assembled with each other and an assembling work for the leaf spring and the case is not required.

Another object of the present invention is to provide a lens transfer device improved in assemblability, which can improve an yield by preventing damage of a leaf spring, which may be caused during an assembling process, and can easily control tolerance in a direction of an optical axis by simply adjusting a relative position between the leaf spring and the barrel holder.

Still another object of the present invention is to provide a lens transfer device improved in assemblability, which employs two leaf springs so that no guide unit is necessary.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a lens transfer device includes a barrel holder, in which a lens barrel having at least one lens therein is mounted, reciprocating in a direction of an optical axis of the lens, an upper case including a first holder connector having a protrusion snap-fitted into a groove formed on an upper-outer circumference of the barrel holder, a first leaf spring whose inner circumferential portion is connected to an outer circumferential portion of the first holder connector, and a first body connected to an outer circumferential portion of the first leaf spring, a lower case including a second holder connector having a protrusion snap-fitted into a groove formed on a lower-outer circumference of the barrel holder, a second leaf spring whose inner circumferential portion is connected to an outer circumferential portion of the second holder connector, and a second body connected to an outer circumferential portion of the second leaf spring, a yoke allowing a magnet assembly to be installed therein, the yoke being mounted on the lower case, and a coil moving together with the barrel holder, the coil being spaced by a predetermined gap from the magnet assembly.

The first and second leaf springs may be integrally formed with the first and second bodies through insert molding, respectively.

The first leaf spring is integrally formed with the first body and the first holder connector through insert molding and the second leaf spring is integrally formed with the second body and the second holder connector through insert molding.

The coil may be adhered to a bottom of the first holder connector and spaced by a predetermined gap from the magnet assembly installed in the yoke.

The first and second leaf springs apply an identical elastic force to the barrel holder to securely guide the movement of the barrel holder in the direction of the optical axis.

According to another aspect of the present invention, there is provided a lens transfer device, including: a hollow barrel holder, in which a lens barrel having at least one lens therein is mounted and around which a coil is wound, reciprocating in a direction of an optical axis of the lens; an upper case including a holder connector having a protrusion snap-fitted into a groove formed on an upper-outer circumference of the barrel holder, a leaf spring whose inner circumferential portion is connected to an outer circumferential portion of the holder connector, and a body connected to an outer circumferential portion of the leaf spring; a yoke having a guide plate inserted in a guide hole formed through the barrel holder and a magnet assembly installed therein; and a lower case for allowing the yoke to seat thereon.

The leaf spring may be integrally formed with the body through insert molding.

The leaf spring may be integrally formed with the body and the holder connector through insert molding.

According to still another aspect of the present invention, there is provided a lens transfer device, including: a hollow barrel holder, in which a lens barrel having at least one lens therein is mounted, reciprocating in a direction of an optical axis of the lens; a case including a holder connector having a protrusion snap-fitted into a groove formed on an outer circumference of the barrel holder, a leaf spring whose inner circumferential portion is connected to an outer circumferential portion of the holder connector, and a body connected to an outer circumferential portion of the leaf spring; a yoke having a magnet assemble, the yoke being mounted on the case; and a coil moving together with the barrel holder, the coil being spaced by a predetermined gap from the magnet assembly.

The leaf spring may be integrally formed with the body through insert molding and the leaf spring may be integrally formed with the body and the holder connector through insert molding.

The coil may be adhered to the holder connector and is spaced by a predetermined gap from the magnet assembly installed in the yoke.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1A is an exploded perspective view of a lens transfer device according to a related art;

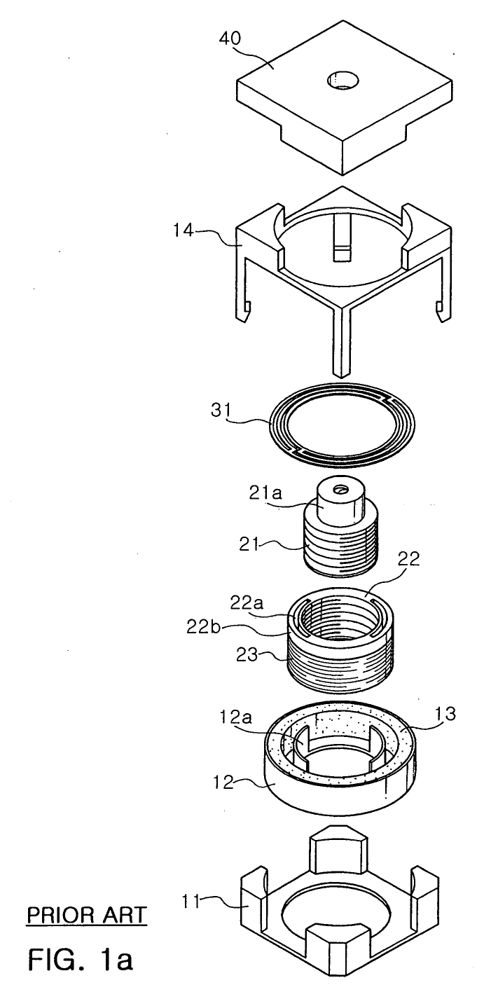

FIG. 1B is a sectional view of the lens transfer device depicted in FIG. 1A when it is assembled;

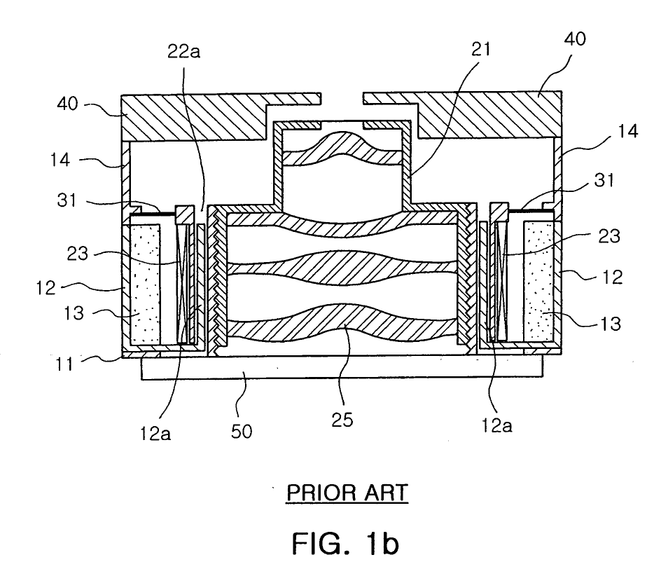

FIG. 2A is an exploded perspective view of a lens transfer device according to an embodiment of the present invention;

FIG. 2B is a sectional view of the lens transfer device depicted in FIG. 2A when it is assembled;

FIG. 3A is an enlarged exploded perspective view of an upper case, lower case and barrel holder that are depicted in FIGS. 2A and 2B;

FIG. 3B is a sectional view of the upper case, lower case and barrel holder that are depicted in FIG. 3A when they are assembled with each other;

FIG. 4 is a partly broken perspective view of an upper case depicted in FIGS. 2A and 2B;

FIG. 5a is an exploded perspective view of a lens transfer device according to another embodiment of the present invention; and

FIG. 5b is a sectional view of the lens transfer device depicted in FIG. 5a when it is assembled;

### DETAILED DESCRIPTION OF THE INVENTION

Reference will now be made in detail to the preferred embodiments of the present invention, examples of which are illustrated in the accompanying drawings.

The present invention is directed to a lens transfer device improved in assemblability, in which a leaf spring is integrally formed with a case through insert molding and a holder connector and a barrel holder are snap-fitted to the leaf spring. This will be described in more detail with reference to the accompanying drawings.

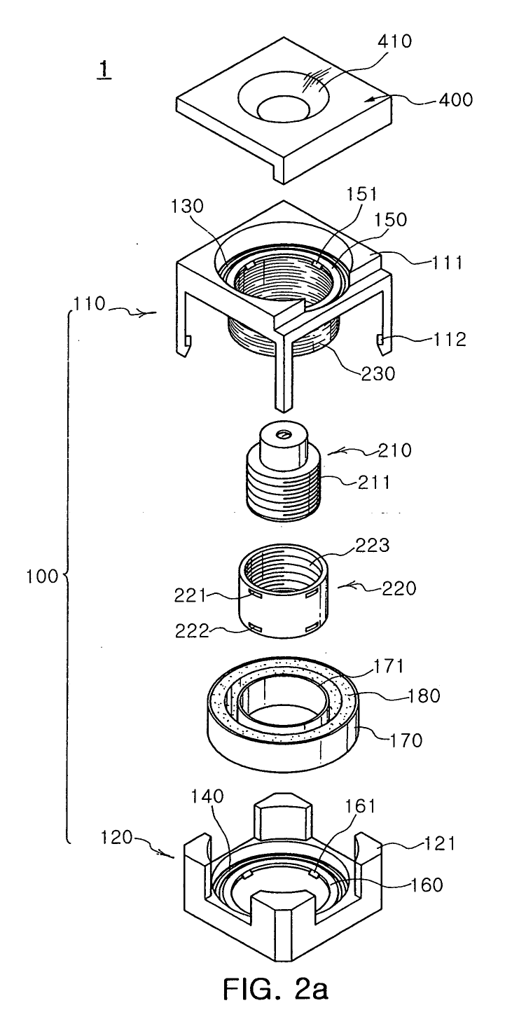

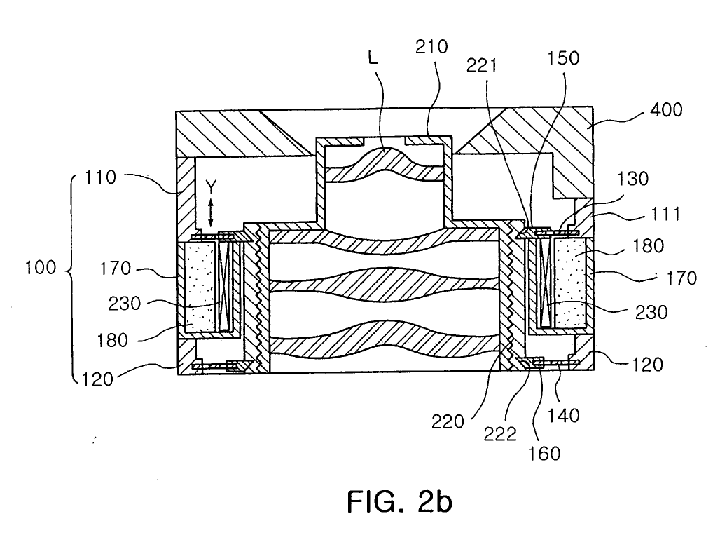

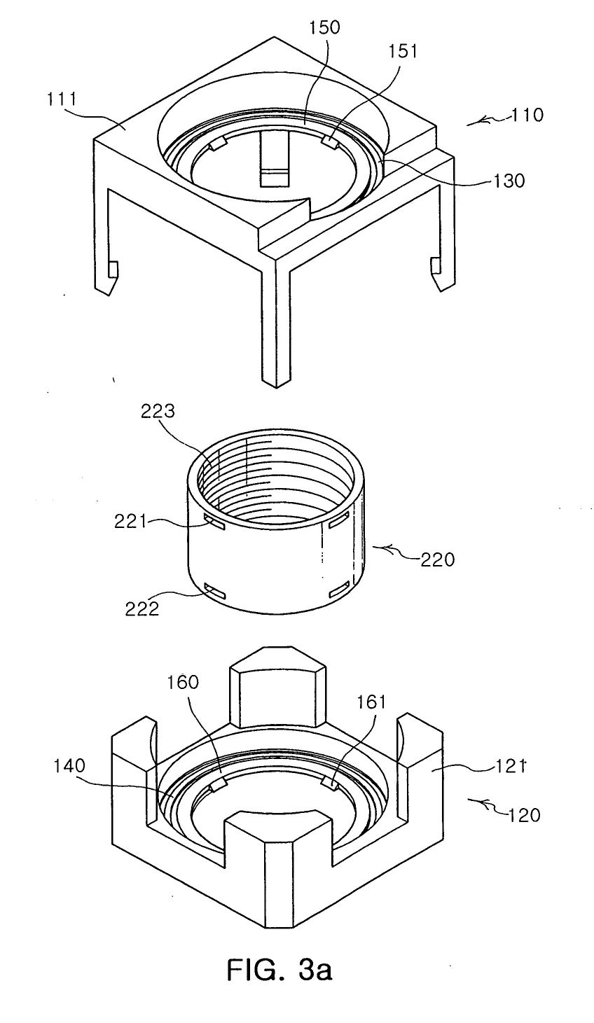

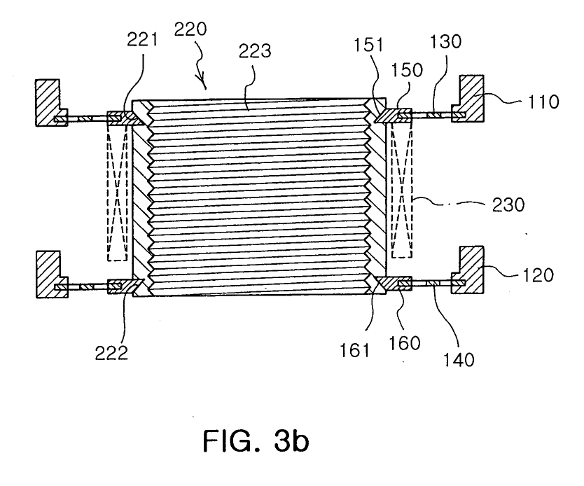

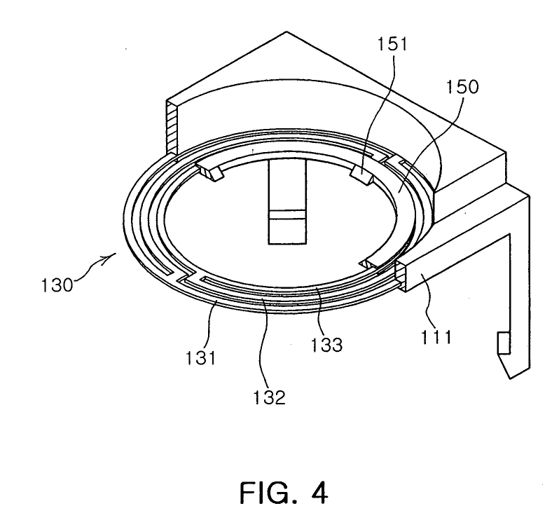

FIG. 2A is an exploded perspective view of a lens transfer device according to an embodiment of the present invention, FIG. 2B is a sectional view of the lens transfer device depicted in FIG. 2A when it is assembled, FIG. 3A is an enlarged exploded perspective view of an upper case, lower case and barrel holder that are depicted in FIGS. 2A and 2B, FIG. 3B is a sectional view of the upper case, lower case and barrel holder that are depicted in FIG. 3A when they are assembled with each other, and FIG. 4 is a partly broken perspective view of a upper case depicted in FIGS. 2 and 2B.

As shown in FIGS. 2A and 2B, a lens barrel 210 with at least one lens L is mounted inside a barrel holder 220. At this point, the number of lenses L may be one or more according to a desired function and performance of a camera. Some of the lenses may be formed to maintain their fixed locations even when the barrel holder 220 moves. A thread 211 formed on an outer circumference of the lens barrel 210 is screw-coupled to a thread 223 formed on an inner circumference of the barrel holder 220. Meanwhile, formed on the outer circumference of the barrel holder 220 are grooves 221 and 222 to which holder connectors 151 and 162 are snap-fitted. This will be described later.

In addition, a cylindrical magnet assembly 180 for generating magnetic force is installed inside a yoke 170. The yoke 170 may be formed with a U-shaped section to intermittent magnetic flux.

At this point, a coil 230 is disposed on an inner circumference of the cylindrical magnet assembly 180 with a predetermined gap therebetween. The coil 230 is electrically connected to a power source (not shown) to receive electric power from the power source. Therefore, when the electric power is applied to the coil 230, the coil 230 moves by electromagnetic force interacting on the coil 230 and the cylindrical magnet assembly 180.

Meanwhile, a lens transfer device 1 of this embodiment includes a case 100 having upper and lower cases 110 and 120. The case 100 defines a predetermined internal space in which the yoke 170 and the barrel holder 220 are installed. That is, the case 100 protects components mounted therein from outer impact.

At this point, the upper case 110 has a first holder connector 150 having protrusions 151 snap-fitted to the grooves 221 formed on an upper-outer circumference of the barrel holder 220, a first leaf spring 130 whose inner circumferential portion is connected to an outer circumferential portion of the first holder connector 150, and a first body 111 connected to the outer circumferential portion of the first leaf spring 130.

Likewise, the lower case 120 has a second holder connector 160 having protrusions 161 snap-fitted to the grooves 222 formed on a lower-outer circumference of the barrel holder 220, a second leaf spring 140 whose inner circumferential portion is connected to an outer circumferential portion of the second holder connector 160, and a second body 121 connected to the outer circumferential portion of the second leaf spring 140.

The body 111, the leaf spring 130 and the holder connector 150 may be integrally formed with each other through insert molding. Likewise, the body 121, the leaf spring 140 and the holder connector 160 may be integrally formed with each other through insert molding.

At this point, the leaf springs 130 and 140 may be formed of metal capable of providing sufficient strength and elastic force. The bodies 111 and 121 and the holder connectors 150 and 160 may be formed of plastic material.

FIGS. 3A and 3B shows a combination of the upper and lower case bodies 110 and 120 and the barrel holder 220 in detail.

As shown in the drawings, the protrusions 151 of the first holder connector 150 of the upper case 110 are snap-fitted to the grooves 221 formed on the upper-outer circumference of the barrel holder 220. The protrusions 161 of the second holder connector 160 of the lower case bodies 120 are snap-fitted to the grooves 222 formed on the lower-outer circumference of the barrel holder 220.

In the related art, since the leaf spring is forcedly fitted to the barrel holder and fixed thereto through the bonding process, the leaf spring may be damaged or broken during the assembling process, the yield may be deteriorated. In addition, the assembling process is complicated and it is difficult to control the tolerance in the direction of the optical axis. However, according to the present invention, since the leaf spring is connected to the barrel holder through a snap-fit method, problems due to the limitations and disadvantages of the related art can be avoided.

Preferably, as shown in FIGS. 2B and 3B, the coil 230 may be adhered to a bottom of the first holder connector 150 through a bonding process and spaced by a predetermined gap away from the magnet 180 installed in the yoke 170. When the coil is installed as described above, since there is no need to directly wind the coil 230 around the barrel holder 220, the barrel holder 220 can be manufactured through a simple manufacturing process and design flexibility of the barrel holder 22 can be improved.

Referring to FIG. 4, the circular shaped leaf spring 130 includes an outer circumferential portion 131, an inner circumferential portion 133 and an intermediate circumferential portion 132 formed between the outer and inner circumferential portions 131 and 133. The outer and inner circumferential portions 131 and 133 are integrally formed with the body 111 and the holder connector 150, respectively, through insert molding. The intermediate circumferential portion is elastically deformed to provide displacement required for moving the barrel holder 220. In addition, the protrusions 151 formed on the inner circumference of the holder connector 150 are snap-fitted to the grooves 221 formed on the barrel holder 220.

Alternatively, the outer circumferential portion 131 may be insert-molded to the body 111 and the inner circumferential portion 133 may be adhered to the holder connector 150 through the bonding process.

A structure of the leaf spring 130 depicted in FIG. 4 is simply exemplary, not limiting the present invention. Any structures that can be insert-molded may be applied to the present invention.

The leaf spring 140 may be also integrally formed with the lower case 120 through insert molding.

Preferably, as shown in FIGS. 2B and 3B, the first and second leaf springs 130 and 140 may be formed to apply identical elastic force to the barrel holder 220.

That is, when the identical elastic force is applied to upper and lower portions of the barrel holder 220, the barrel holder 220 can accurately reciprocate in the direction of the optical axis by the interaction of the first and second leaf springs 130 and 140 even when there is no guide unit for guiding the reciprocation of the barrel holder 220.

Therefore, although it is preferable that the first and second leaf springs 130 and 140 are formed in an identical shape and material, the present invention is not limited to this. That is, any shapes and materials can be used as far as the first and leaf springs 130 and 140 can apply identical elastic force to the barrel holder 220.

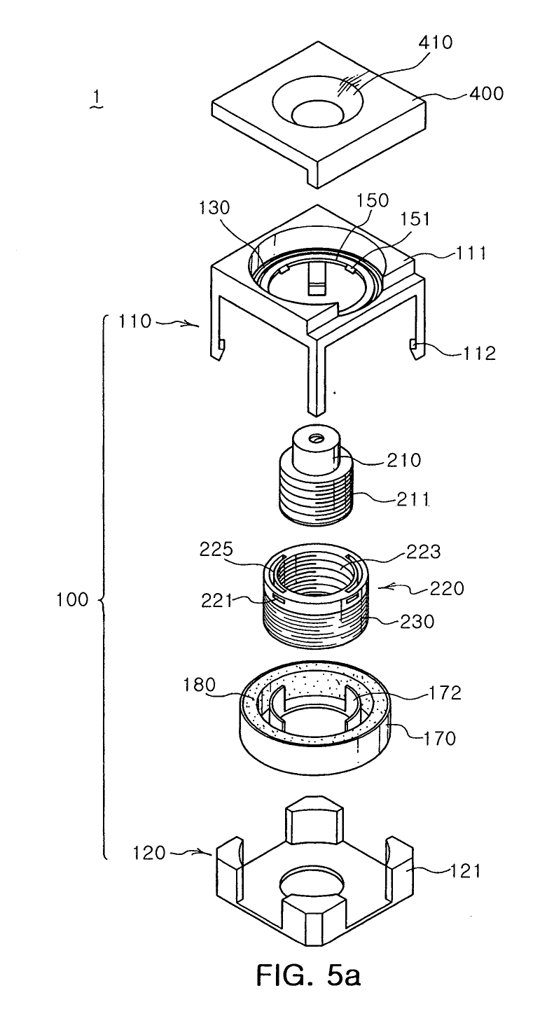

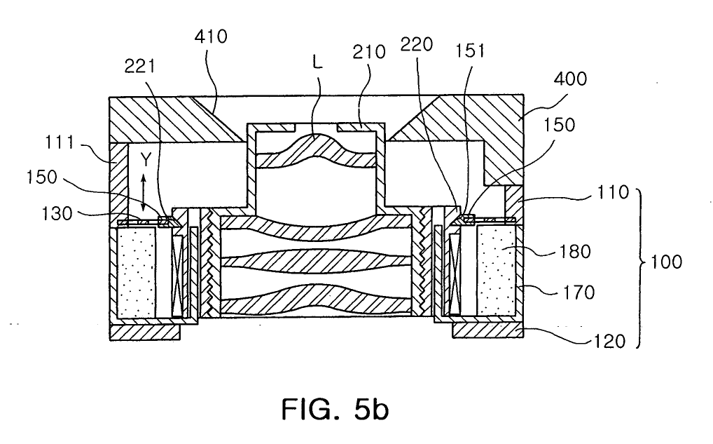

FIG. 5a is an exploded perspective view of a lens transfer device according to another embodiment of the present invention and FIG. 5b is a sectional view of the lens transfer device depicted in FIG. 5a when it is assembled.

As shown in FIG. 5, a lens transfer device 1 of this embodiment includes a barrel holder 220 around which a coil is wound, an upper case 110 connected to a first leaf spring 130, a yoke 170 in which a magnet assembly is disposed, and a lowercase 170 on which the yoke 170 seats.

The lens transfer device of this embodiment is substantially identical to that of the foregoing embodiment except that the coil 230 is wound around the barrel holder 220, guide holes are formed through the barrel holder 220, and neither a leaf spring nor a holder connector is provided on the lower case.

The lens transfer device, especially the different constitutions from the foregoing embodiment, will be now described.

As shown in FIG. 5, grooves 221 are formed on only an upper-outer circumference of the barrel holder 220. Snap-fitted to the grooves 221 are protrusions 151 formed on the holder connector 150 connected to the first leaf spring 130 of the upper case 110.

As described above, the coil 230 is wound around the barrel holder 220 and the guide holes 225 are formed through the barrel holder 220. By the guide holes 225, the coil 230 can be disposed in the yoke 170 and spaced by a predetermined gap from the magnet assembly 180 disposed in the yoke.

That is, formed inside the yoke 170 are guide plates 172 inserted in the guide holes 225. Therefore, the guide holes 225 and the guide plates 172 function to guide the reciprocation of the barrel holder 220 in the direction of the optical axis and to locate the coil 230 in the yoke 170 such that the coil 230 is spaced by the predetermined gap from the magnet assembly 180.

In this embodiment, the leaf spring 130 is integrally formed with only the upper case 110 through insert molding and the reciprocation motion of the barrel holder in the direction of the optical axis is guided by the guide plates 172 and the guide holes 225.

In the above-described embodiments, although the yoke 170 is formed with the U-shaped section, the present invention is not limited to this. That is, the yoke 170 may be formed with a L-shaped section. Alternatively, a yoke having a ∩-shaped section may be applied to the present invention.

When the yoke is formed with the ∩-shaped section, the coil 230 is designed to be inserted upward in the yoke 170 and, in the case of the second embodiment, the leaf spring is associated with the lower case 120.

In addition, if the reciprocation in the direction of the optical axis is guaranteed, the holder connector having the leaf spring and protrusions may be provided on only one of the upper and lower portions of the upper case 110 or the lower case 120.

The operation of the above-described lens transfer device of the present invention will be now described.

As shown in FIG. 2B, when current is applied to the coil 230, the coil 23 linearly moves by electromagnetic force generated by the coil and the magnet assembly 180 according to the Fleming's left-hand rule.

In the case of the first embodiment, the transfer force is applied to the holder connector 150 adhered to the coil 230, by which the leaf spring 130 connected to the holder connector 150 is elastically deformed to provide the displacement required for the reciprocation motion of the barrel holder 220.

That is, by the current applied to the coil 230, the barrel holder 220 moves in the direction of the optical axis Y of FIG. 2B. As a result, the lens L installed in the lens barrel 210 mounted in the barrel holder 220 moves. Therefore, a relative distance between an image sensor (not shown) and the lens L varies to adjust the focusing and zooming.

At this point, by the balance between the elastic forces applied by the first and second leaf springs 130 and 140, the movement in the direction of the optical axis can be accurately realized even when there is no special guide unit.

Meanwhile, in the case of the second embodiment, as shown in FIG. 5b, when the current is applied to the coil 230, the barrel holder 220 around which the coil is wound transfers. At this point, the transfer in the direction of the optical axis Y is reliably realized by the guide plates 172 inserted in the guide holes 225.

According to the present invention, since the leaf spring is integrally formed with the case, there is no need for a process for assembling the leaf spring with the case. In addition, since the holder connector having the protrusions is associated with the leaf spring and the barrel holder is provided with the grooves in which the protrusions is snap-fitted, the process for assembling the leaf spring and the barrel holder can be simplified, thereby improving the assemblability.

Also, unlike the related art where the leaf spring is forcedly fitted, since the leaf spring is snap-fitted to the barrel holder, the damage or breakage of the leaf spring can be prevented, thereby improving the yield.

Furthermore, since the leaf spring is integrally formed with the case through the insert molding, the tolerance in the direction of the optical axis can be easily controlled through the simple snap-fit. In addition, since there is no need of the bonding process, the variation of the elastic force, which may be caused by the bonding process, can be prevented.

Also, when two leaf springs are associated with the respective upper and lower cases, a special guide unit is not necessary.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A lens transfer device, comprising:
a barrel holder, in which a lens barrel having at least one lens therein is mounted, reciprocating in a direction of an optical axis of the lens;
an upper case including a first holder connector having a protrusion snap-fitted into a groove formed on an upper-outer circumference of the barrel holder, a first leaf spring whose inner circumferential portion is connected to an outer circumferential portion of the first holder connector, and a first body connected to an outer circumferential portion of the first leaf spring;
a lower case including a second holder connector having a protrusion snap-fitted into a groove formed on a lower-outer circumference of the barrel holder, a second leaf spring whose inner circumferential portion is connected to an outer circumferential portion of the second holder connector, and a second body connected to an outer circumferential portion of the second leaf spring;
a yoke allowing a magnet assembly to be installed therein, the yoke being mounted on the lower case; and
a coil moving together with the barrel holder, the coil being spaced by a predetermined gap from the magnet assembly.

2. The lens transfer device of claim 1, wherein the first and second leaf springs are integrally formed with the first and second bodies through insert molding, respectively.

3. The lens transfer device of claim 1, The first leaf spring is integrally formed with the first body and the first holder connector through insert molding and the second leaf spring is integrally formed with the second body and the second holder connector through insert molding.

4. The lens transfer device of claim 1, wherein the coil is adhered to a bottom of the first holder connector and spaced by a predetermined gap from the magnet assembly installed in the yoke.

5. The lens transfer device of claim 1, wherein the first and second leaf springs apply an identical elastic force to the barrel holder to securely guide the movement of the barrel holder in the direction of the optical axis.

6. A lens transfer device, comprising:
a hollow barrel holder, in which a lens barrel having at least one lens therein is mounted and around which a coil is wound, reciprocating in a direction of an optical axis of the lens;
an upper case including a holder connector having a protrusion snap-fitted into a groove formed on an upper-outer circumference of the barrel holder, a leaf spring whose inner circumferential portion is connected to an outer circumferential portion of the holder connector, and a body connected to an outer circumferential portion of the leaf spring;
a yoke having a guide plate inserted in a guide hole formed through the barrel holder and a magnet assembly installed therein; and
a lower case for allowing the yoke to seat thereon.

7. The lens transfer device of claim 6, wherein the leaf spring is integrally formed with the body through insert molding.

8. The lens transfer device of claim 6, wherein the leaf spring is integrally formed with the body and the holder connector through insert molding.

9. A lens transfer device, comprising:
a hollow barrel holder, in which a lens barrel having at least one lens therein is mounted, reciprocating in a direction of an optical axis of the lens;
a case including a holder connector having a protrusion snap-fitted into a groove formed on an outer circumference of the barrel holder, a leaf spring whose inner circumferential portion is connected to an outer circumferential portion of the holder connector, and a body connected to an outer circumferential portion of the leaf spring;
a yoke having a magnet assemble, the yoke being mounted on the case; and
a coil moving together with the barrel holder, the coil being spaced by a predetermined gap from the magnet assembly.

10. The lens transfer device of claim 9, wherein the leaf spring is integrally formed with the body through insert molding.

11. The lens transfer device of claim 9, wherein the leaf spring is integrally formed with the body and the holder connector through insert molding.

12. The lens transfer device of claim 9, wherein the coil is adhered to the holder connector and is spaced by a predetermined gap from the magnet assembly installed in the yoke.
